(19) United States
(12) Patent Application Publication
(10) Pub. No.: US 2006/0095304 A1
(43) Pub. Date: May 4, 2006

(54) Evaluating risk of insuring an individual based on timely assessment of motor vehicle records

(75) Inventors: Bill Madison, Alpharetta, GA (US); Jeanne Trocheck, Roswell, GA (US)

Correspondence Address: KING & SPALDING LLP, 191 PEACHTREE STREET, N.E., 45TH FLOOR, ATLANTA, GA, 30303-1763, US

(73) Assignee: ChoicePoint, Asset Company, Wilmington, DE (US)

(21) Appl. No.: 11/261,334

(22) Filed: Oct. 28, 2005

Related U.S. Application Data
(60) Provisional application No. 60/623,596, filed on Oct. 29, 2004.
(60) Provisional application No. 60/657,278, filed on Mar. 1, 2005.

(51) Int. Cl. G06Q 40/00; G06F 17/21

(52) U.S. Cl. 705/4; 715/513

(57) ABSTRACT

Automated generation of reports based on insured persons' motor vehicle records. Insurance carriers can automatically obtain, at appropriate times, customized reports for use in monitoring and assessing insured persons. Incident data regarding the insured persons' motor vehicle records is received and translated, according to the insurance carriers' pre-set designations, into a customized report. For example, the insurance carriers can designate the reports' format, content, generation times, and output times. Such designations can depend upon other insurance-carrier-specific designations. For example, the designations can depend upon whether certain incident data is deemed “selective” or “non-selective.” For example, selective information can be more urgent to the insurance carrier than non-selective information. Allowing insurance carriers to designate when, how, and in what format, they wish to receive each of various types of information permits for more effective, more efficient, continuous monitoring and assessment of insured persons.

### RELATED PATENT APPLICATIONS

This patent application claims priority under 35 U.S.C. § 119 to U.S. Provisional Patent Application No. 60/623,596, entitled “Method and System for Insurance Coverage Verification,” filed Oct. 29, 2004, and U.S. Provisional Patent Application No. 60/657,278, entitled “Method and System for Evaluating Risk of Insuring an Individual Based on Timely Assessment of Motor Vehicle Records,” filed Mar. 1, 2005. The complete disclosure of the above-identified applications is hereby fully incorporated herein by reference.

### TECHNICAL FIELD

The invention relates generally to the effective monitoring and assessment of insured persons, and, more specifically, to the automated generation and output, at appropriate times, of customized reports based on insured persons' motor vehicle records.

### BACKGROUND OF THE INVENTION

Insurance carriers are in the business of risk analysis. When evaluating whether, for what price, and at what coverage level, to insure potential and existing customers, insurance carriers must effectively evaluate both existing and potential risks.

To be effective, such evaluation must be continuous in nature. A person's risk profile can change rapidly. One day, a person can have a clean driving record, making him a low-risk insurance candidate. The next day, that same presumably low-risk candidate can cause an automobile accident that tarnishes his record and makes him a higher-risk insurance candidate. To take into account the dynamic nature of both risk profiles and the behavior of persons in general, insurance carriers must continuously monitor and assess the risk-profiles of the persons that they insure.

Conventionally, insurance carriers have approached the need for effective and continuous monitoring and assessment by searching and analyzing a variety of records for each (potential and existing) insured person. For example, such records can comprise information regarding each insured person's insurance track record and driving history.

In the auto insurance industry, searches of state motor vehicle records are typical. Generally, such searches are done on a state-by-state and person-by-person basis, consuming much of the insurance carriers' time, money, and other resources—commonly, prohibitively so. Therefore, the need for continuous monitoring and assessment is typically unmet.

After obtaining records for a particular insured person, the insurance carrier must analyze each record and determine whether and/or how the record impacts the insured person's risk profile. The insurance carrier must also determine whether and/or how the impact on the risk profile should change the insured person's policy pricing and/or insurance coverage level.

The answers to these questions require a two-fold analysis. First, under state insurance laws and internal policy guidelines, when, if at all, can the insurance carrier consider the risk-relevant information contained in an insured person's record in making pricing and/or coverage changes? Second, if and when the information is considered, what pricing and/or coverage changes should be made?

A number of state laws and internal insurance carrier policy guidelines prohibit insurance carriers from considering certain information in making pricing and/or coverage level decisions. Even if allowed to consider the information, insurance carriers frequently are prohibited from using the information at certain designated times. For example, in the context of auto insurance, insurance carriers generally are prohibited from considering insured persons' “minor” motor vehicle incidents until the insured persons' insurance policies are due to renew.

In addition, many insurance carriers prefer to delay acting on certain information for internal policy reasons. For example, an insurance carrier may prefer to delay acting on a minor motor vehicle incident because it deems such an incident to be unlikely to immediately influence policy pricing or coverage decisions.

Existing approaches fail to adequately distinguish one record from another. As a result they provide insurance carriers with unfiltered, unnecessary, and often-times, undesired information. If an insurance carrier cannot (or does not want to) consider certain information at a certain time, the insurance carrier still must obtain a record, evaluate it, and determine whether it contains information that can and should be considered.

Compounding these problems is the fact that generally, each record originates from a separate source. Under existing approaches, insurance carriers must be familiar with each source, know the process for obtaining a record from each source, and recognize and understand each source's particular record format. Further, for each insured person, the insurance carriers must draw together relevant, usable information from multiple records.

In view of the foregoing, a need exists in the art for systems and methods for effectively, efficiently, and continuously monitoring and evaluating risk-relevant information regarding insured persons. In addition, a need exists in the art for such systems and methods to obtain the risk-relevant information from at least one information source. Further, a need exists in the art for the systems and methods to output the risk-relevant information in a format, and at a time, that is desirable to an information recipient. In particular, a need exists in the art for the systems and methods to output the risk-relevant information in a manner that comports with state law-specific and insurance carrier-specific guidelines for which information can and should, and at which times, be considered.

### SUMMARY OF THE INVENTION

The invention provides systems and methods for more effectively assessing insured persons. Specifically, the invention allows an insurance carrier to timely receive automatically-generated reports based on insurance recipients' motor vehicle records. By allowing insurance carriers to customize the content, format, and timing of both the generation and output of such reports, the invention helps insurance carriers effectively, efficiently, and continuously monitor and evaluate their insurance recipients.

In one aspect, the invention provides methods and systems for automatically generating and outputting, at appropriate times, customized reports based on insured persons' motor vehicle records. A policy monitoring module can generate the customized reports using insured data, policy data, and/or rule data.

The insured data comprises information regarding an insured person. For example, the insured data can comprise identification information for the insured person and/or background information regarding the insured person. The policy data comprises information regarding at least one insurance policy. For example, the policy data can comprise the corresponding policy's renewal date. The policy data can also comprise information identifying each insured person insured on each corresponding insurance policy.

The rule data comprises designations for the format, content, report generation timing, and/or report output timing for each report. For example, a recipient of the report(s) can create the rule data. Alternatively, the rule data can comprise pre-set and/or standard designations. Each designation can itself depend upon one or more other designations.

For example, certain of the designations can depend upon whether particular information considered in the generation of each report is deemed “selective” or “non-selective.” The rule data can designate that the format, content, and/or output time of a report depends upon whether the particular information considered in the generation of the report is selective or non-selective. The rule data can also designate a particular report recipient's definition for when information is selective or non-selective. For example, selective information can be more urgent to the report recipient than non-selective information. By way of example only, a non-selective incident can be a “minor incident” and a selective incident can be a “major incident,” as those terms are defined by a corresponding state and/or incident data source.

Utilizing the insured data, the policy data, and/or the rule data, the policy monitoring module obtains incident data from an incident data source. The incident data comprises information regarding an insured person's motor vehicle record. For example, the policy monitoring module can obtain the incident data by submitting insured data to an incident data source. The obtained incident data can correspond to the submitted insured data.

The policy monitoring module utilizes the incident data to generate a report based upon an insured person's motor vehicle record. For example, the policy monitoring module can apply each designation of the rule data to the incident data to generate a report in accordance with a report recipient's preferences. If a designation depends on whether certain incident data is selective and/or non-selective, as those terms are defined by the rule data, the policy monitoring module can determine whether the certain incident data is selective and/or non-selective prior to generating a report.

Upon generation of a report, a reporting module can store the report in a data storage medium. Depending on the rule data, the reporting module also can output the report. Output times can vary from report to report, depending on the rule data. For example, the rule data can designate that the output time for each report depends on whether the report comprises non-selective information. The reporting module can determine whether the report comprises non-selective information before outputting the report. The output time for each report can depend on other information, including, e.g., an insurance policy renewal date or an insured person's birth date.

In outputting each report, the reporting module can combine the contents of multiple reports together. For example, the reporting module can combine the contents of reports that have the same output times. In addition, the reporting module can combine the contents of reports that have output times before or at the then-current time. In combining the reports' contents, the reporting module can generate a single “batched” report comprising all of the information from each combined report. The reporting module can output the batched report at an appropriate time.

These and other aspects, objects, features, and advantages of the invention will become apparent to a person skilled in the art upon consideration of the following detailed description of illustrated exemplary embodiments, which include the best mode of carrying out the invention as presently perceived.

### BRIEF DESCRIPTION OF THE DRAWINGS

FIG. 1 is a block diagram depicting a system for generating and outputting at appropriate times customized reports regarding insured persons, according to an exemplary embodiment of the invention.

FIG. 2 is a block diagram depicting a control module of a system for generating and outputting at appropriate times customized reports regarding insured persons, according to an exemplary embodiment of the invention.

FIG. 3 is a flow chart depicting a method for generating and outputting at appropriate times customized reports regarding insured persons, according to an exemplary embodiment of the invention.

FIG. 4 is a flow chart depicting a method for generating a customized report regarding an insured person, according to an exemplary embodiment of the invention.

FIG. 5 is a flow chart depicting a method for generating a policy monitoring report, according to an exemplary embodiment of the invention.

FIG. 6 is a flow chart depicting a method for generating and outputting at appropriate times customized policy monitoring reports, according to an exemplary embodiment of the invention.

### DETAILED DESCRIPTION OF EXEMPLARY EMBODIMENTS

The invention is directed to automated generation and output, at appropriate times, of customized reports based on insured persons' motor vehicle records. Effective evaluation of insured persons' motor vehicle records can help insurance carriers efficiently and accurately understand existing potential and existing risks of insured persons. In addition, such effective evaluation can help insurance carriers more effectively forecast budgets and set pricing levels. It can also help insurance carriers limit potential liabilities and costs.

The term “insurance carrier” is used herein to refer to a provider of insurance. For example, an insurance carrier can provide auto and/or property insurance to at least one insured person. The term “insured person” is used herein to refer to any person insured by at least one insurance carrier.

In accordance with an exemplary embodiment of the invention, insurance carriers can automatically obtain, at appropriate times, customized reports for use in monitoring the motor vehicle records of insured persons. In particular, the insurance carriers can use the customized reports to evaluate the risk profiles of insured persons based on the insured persons' motor vehicle records. For example, the customized reports can indicate whether each insured person's motor vehicle record comprises information regarding a “selective incident.”

A “selective incident” is a motor vehicle incident for which the insurance carrier prefers to be immediately notified. For example, the insurance carrier might prefer to be immediately notified because it deems a selective incident likely to immediately influence policy pricing or coverage decisions. In contrast, a “non-selective incident” is a motor vehicle incident for which the insurance carrier prefers to delay notification. For example, the insurance carrier might prefer to delay notification because of a present inability of the insurance carrier, for legal reasons or otherwise, to base pricing or coverage level changes on a non-selective incident. The insurance carrier might also prefer to delay notification of a non-selective incident because the insurance carrier deems a non-selective incident unlikely to immediately influence policy pricing or coverage decisions.

According to pre-set designations of each insurance carrier, the customized reports can comprise information regarding the insured persons, the insured persons' motor vehicle records, and/or the insured persons' insurance policies. For example, the insurance carriers can designate the reports' format, content, generation times, and output times. Allowing insurance carriers to designate when, how, and in what format, they wish to receive the reports permits for more effective, more efficient, continuous evaluation of insured persons.

The term “report” is used herein to refer to any data and/or output created in accordance with an exemplary embodiment of the present invention. For example, a report can comprise comprehensive information regarding an insured person's motor vehicle record. Alternatively, the report can comprise an acknowledgment that the system failed to find any pertinent information.

The invention comprises a computer program that embodies the functions described herein and illustrated in the appended flow charts. However, it should be apparent that there could be many different ways of implementing the invention in computer programming, and the invention should not be construed as limited to any one set of computer program instructions. Further, a skilled programmer would be able to write such a computer program to implement an embodiment of the disclosed invention based on the flow charts and associated description in the application text. Therefore, disclosure of a particular set of program code instructions is not considered necessary for an adequate understanding of how to make and use the invention. The inventive functionality of the claimed computer program will be explained in more detail in the following description read in conjunction with the figures illustrating the program flow.

Turning now to the drawings, in which like numerals indicate like elements throughout the figures, exemplary embodiments of the invention are described in detail.

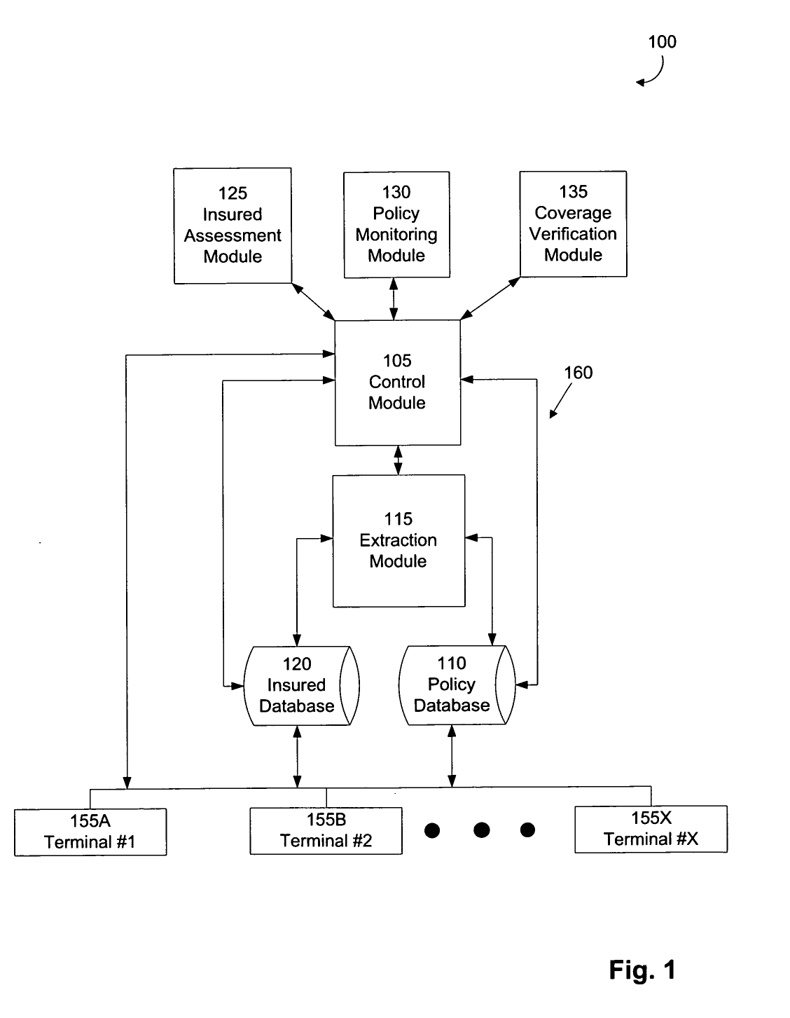

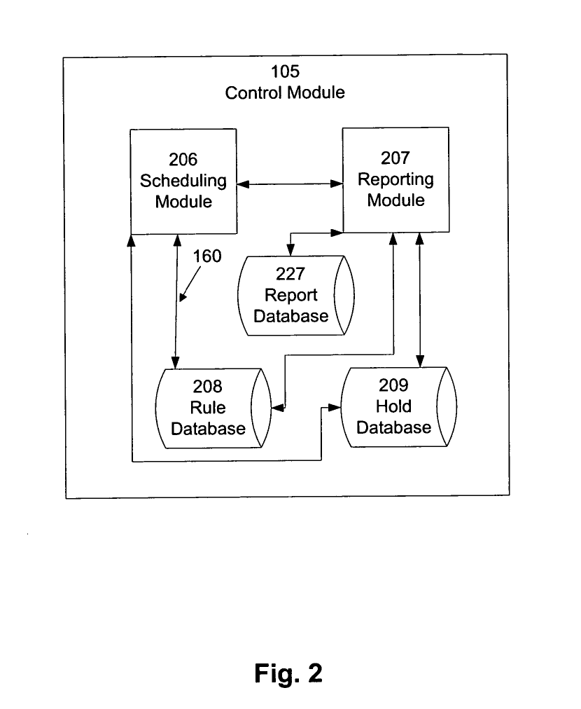

An exemplary system for generating and outputting at appropriate times customized reports regarding insured persons will now be described with reference to FIGS. 1-2. FIG. 1 is a block diagram depicting a system 100 for generating and outputting at appropriate times customized reports regarding insured persons, according to an exemplary embodiment of the invention. FIG. 2 is a block diagram depicting a control module 105 of the system 100, according to an exemplary embodiment of the invention. A person skilled in the art will appreciate that FIGS. 1-2 and the associated discussion are intended to provide a general description of representative computer devices and program modules for implementing the exemplary embodiment.

The exemplary system 100 includes an arrangement of computer-based components coupled to one another through a set of data links 160 such as a network 160. While some of the system's functions are implemented in a single system component, other functions are dispersed among components. The information structure of the system 100 offers a distributed computing environment. In this environment, the code behind the software-based process steps does not necessarily execute in a singular component; rather, the code can execute in multiple components of the system 100.

The system's communication network 160, a network of data links, facilitates information flow between the components. For a system 100 in which all elements are located at the same site, a local area network may provide the backbone for the system's communication network 160. In a system 100 with geographically dispersed components, the communications network 160 may comprise a wide area network, a virtual network, a satellite communications network, or other communications network elements as are known in the art.

In an exemplary application of the system 100, at least one insurance carrier's policy data is stored in a policy database 110. The policy data comprises each insurance carrier's insurance policy information, such as: (1) the insurance carrier's A.M. Best number (a carrier-specific numerical identifier); (2) the insurance carrier's National Association of Insurance Commissioners (NAIC) number (a carrier-specific numerical identifier); (3) a PIN number for each person insured by the insurance carrier; (4) a designation, for each policy, of which insured person is the primary policyholder; (5) the type of insurance (e.g., auto or property) provided for under each insurance policy; (6) each insurance policy's policy type, including, e.g., whether the insurance policy is for full (comprehensive) coverage, collision, bodily injury, property damage, catastrophe damage, and/or liability, and the amounts and types of reimbursement provided for under the policy; (7) each insurance policy's insurance inception date; (8) each insurance policy's most recent policy period begin date; (9) each insurance policy's policy period end date; (10) the vehicle identification number of each vehicle, if any, insured on each policy; and/or (11) the vehicle make, model, and model year for each vehicle, if any, insured on each insurance policy.

In one embodiment of the invention, the insurance carrier(s) and/or an agent or agents of the insurance carrier(s) can store the policy data in the policy database 110. For example, the insurance carrier(s) and/or agent(s) can access the policy database 110 via a terminal 155. The terminal 155 can be any device through which data or information can be entered or displayed.

Similarly, insured data of the insurance carrier(s) is stored in an insured database 120. The insured data comprises information regarding persons insured by the insurance carrier(s). For example, the insured data can comprise: (1) the name of each insured person; (2) the address of each insured person; (3) the date of birth of each insured person; (4) one or more PIN numbers for each insured person; (5) the social security number of each insured person; (6) the A.M. Best number of each insurance carrier that provides insurance to each insured person; (7) the driver's license number of each (licensed) insured person; and/or (8) the driver's license state of each (licensed) insured person.

In one embodiment of the invention, the insurance carrier(s) and/or an agent or agents of the insurance carrier(s) can store the insured data in the insured database 120. For example, the insurance carrier(s) and/or agent(s) can access the insured database 120 via the terminal 155.

Rule data of the insurance carrier(s) is stored in a rule database 208 of a control module 105. The rule data comprises each report recipient's (e.g., each insurance carrier's) preferences, and internal rules, for the operation of an exemplary embodiment of the invention. For example, the report recipient preferences can include: (1) which type(s) of report(s) to generate; (2) for which insured person(s) and/or insurance policy(ies) to generate the report(s); (3) what information to include in each report; (4) the format of each report; (5) when to generate each report; (6) how long, if at all, to store each report in a data storage medium; and/or (7) when to output each report, including, e.g., whether to delay outputting certain generated reports until a later “hold date” and/or how to determine the hold date. Each report for which output is delayed is referred to herein as a “hold report.”

If the rule data indicates a report recipient's preference to delay outputting certain generated reports until a later hold date, the rule data can further comprise whether to update the contents of each hold report and/or verify the contents of each hold report on or before the hold date. In addition, the rule data can comprise the report recipient's preference for the date or dates on which to update and/or verify the hold report contents.

The terms “date” and “time” are used interchangeably herein to refer generically to any date, time, or date and time.

In one embodiment of the invention, the report recipient preferences can depend on information retrieved by the system 100 in generating the report(s). For example, the report recipient can designate specific formatting and content preferences that depend on whether the system 100 identifies any selective incident information corresponding to an insured person. If the system 100 identifies any selective incident information corresponding to an insured person, for example, the report recipient may desire an immediately-outputted, detailed report. Alternatively, if the system 100 fails to identify any selective incident information corresponding to an insured person, the report recipient may desire to delay receipt of a succinct report or may even desire not to receive any report. In one embodiment of the invention, unless and until report recipient preferences are stored in the rule database 208, the rule data can comprise pre-set standard designations.

For example, the internal rules for the operation of an exemplary embodiment of the invention can comprise: (1) rules defining how each component of the system 100 interacts, including, e.g., the type, amount, and form of data to transfer from one component of the system 100 to another component of the system 100 for the system 100 to function properly; (2) rules defining how to obtain incident data; and/or (3) rules defining, for each incident source, the type and form of data required to obtain the incident data.

In one embodiment of the invention, the agent(s) of the insurance carrier(s) can store the rule data in the rule database 208. For example, the agent(s) can access the rule database 208 via the terminal 155.

Storage of the policy data, the insured data, and the rule data in the policy database 110, the insured database 120, and the rule database 208, respectively, enables system components to utilize available information about an insurance carrier's preferences, insurance policies, and insured persons to automatically and continuously generate and output at appropriate times customized reports regarding insured persons.

The term “incident” is used herein to refer to any violation by, or action taken with regard to the driver's license of, an insured person. For example, an incident can be a conviction, a serious offense, an accident, placement on probation, driver's license suspension, license revocation, a moving violation, a parking violation, an equipment or other miscellaneous violation, a warning, and/or a financial responsibility, e.g., to a state department of motor vehicles. Motor vehicle incidents may be either major incidents or minor incidents. Typically, each state and/or incident data source defines for itself whether an incident is a major incident or a minor incident.

The term “incident data” is used herein to refer to motor vehicle data obtained from an incident data source. The incident data comprises information regarding an insured person's motor vehicle record. For example, the incident data can be: (1) binary in nature, including positive or negative data, where positive data (such as a “yes”) indicates that the corresponding insured person's full motor vehicle record contains data regarding a motor vehicle incident, and negative data (such as a “no”) indicates that the corresponding insured full motor vehicle record does not contain any data regarding a motor vehicle incident; (2) in list form, listing out each incident in the corresponding insured person's full motor vehicle record; or (3) a full report comprising all motor vehicle record information corresponding to the insured person that is in the possession of the incident data source—i.e., the insured person's full motor vehicle record. For example, an incident data source can be a state motor vehicle department, a public record source, such as a court record source, or an internal or external database.

One exemplary application of the system 100 comprises an extraction module 115 that interacts with the policy database 110, the insured database 120, and/or the rule database 208 to translate certain stored data into hold data comprising a hold date. Depending on the particular application of the system 100, the rule data for a particular insurance carrier can comprise an insurance carrier's specifically designated hold date. In other words, when submitting preferences (in the form of rule data), the insurance carrier can designate a static date (e.g., Dec. 14^{th}, 2004) to be the hold date. In that case, to obtain the hold date, the extraction module 115 simply extracts the hold date from the rule data.

Alternatively, the rule data for a particular insurance carrier can comprise a method for calculating the hold date. The method can utilize the rule data, policy data, and/or insured data. For example, the insurance carrier can designate that the hold date is based on the license issue date of an insured person. For example, the hold date can be X (a designated number) number of days after the license issue date.

The extraction module 115 stores the hold data in a hold database 209 of the control module 105.

In addition to the rule database 208 and the hold database 209, the control module 105 comprises a scheduling module 206, a reporting module 207, and a report database 227. The scheduling module 206 signals the reporting module 207 to generate and output reports at designated times. For example, the times can be designated in the rule data. Integration with the other system components, including without limitation the insured database 120, the policy database 110, and the rule database 208 enables the scheduling module 206 to ensure that it signals the reporting module 207 for action at appropriate times.

In one embodiment of the invention, the scheduling module 206 is linked to the hold database 209. By accessing the hold database 209, the scheduling module 206 can determine the hold date(s) until which each insurance carrier desires to delay output of certain system-generated hold reports. For example, on the hold date(s), the scheduling module 206 can signal the reporting module 207 to output each report. In addition, depending on the rule data, the scheduling module 206 can signal the reporting module to update the contents of each hold report and/or verify the contents of each hold report on or before the hold date.

When signaled by the scheduling module 206 to generate a report, the reporting module 207 submits certain policy data, insured data, and/or rule data to at least one of an insured assessment module 125, a policy monitoring module 130, and a coverage verification module 135. Each of the insured assessment module 125, the policy monitoring module 130, and the coverage verification module 135 is equipped to generate reports. The type(s) and amount(s) of data submitted by the reporting module 207 depend on the rule data.

The insured assessment module 125 is operable to generate insured assessment reports. An insured assessment report is a report comprising information regarding the credit risks of existing and potential insured persons.

The coverage verification module 135 is operable to generate coverage verification reports. A coverage verification report is a report based on the insurance coverage of one or more youthful drivers.

The policy monitoring module 130 is operable to generate policy monitoring reports. A policy monitoring report is a report based on an insured person's motor vehicle record. For example, a policy monitoring report can indicate whether the insured person's motor vehicle record comprises information regarding a selective incident.

Upon each report generation, the reporting module 207 can output the report and/or store the report in a report database 227.

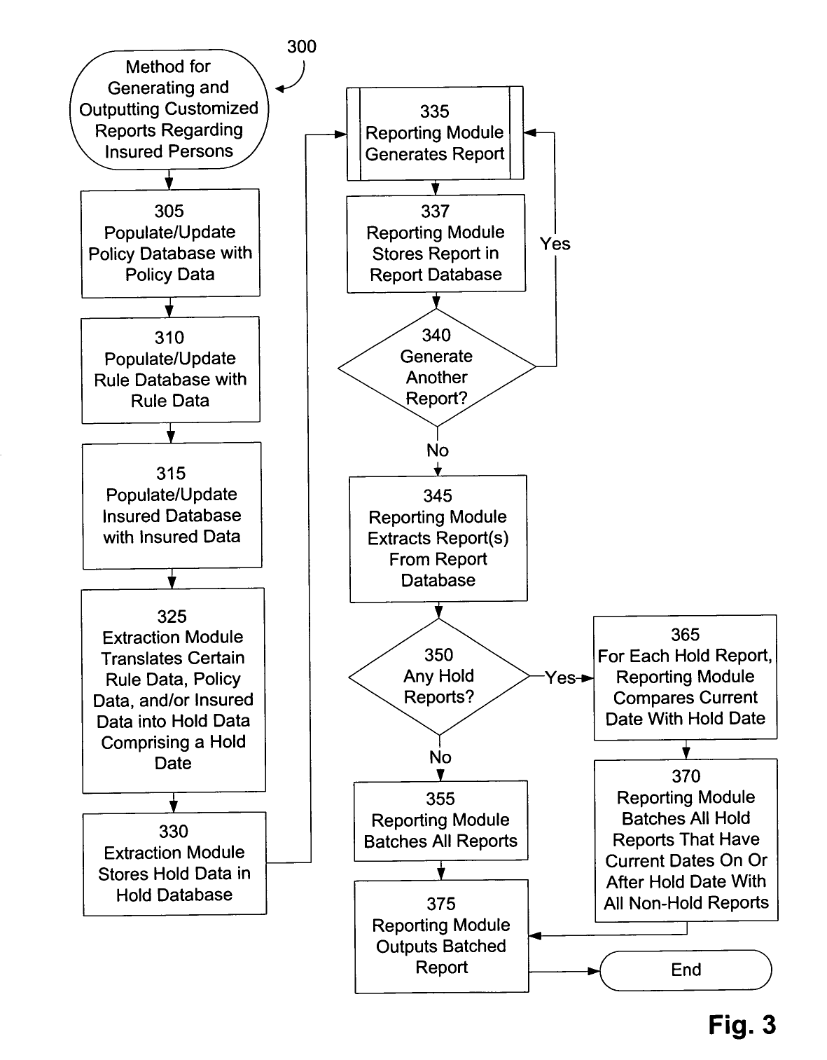

FIG. 3 is a flow chart depicting a method 300 for generating and outputting at appropriate times customized reports regarding insured persons, according to an exemplary embodiment of the invention. The exemplary method 300 is illustrative and, in alternative embodiments of the invention, certain steps can be performed in a different order, in parallel with one another, or omitted entirely, and/or certain additional steps can be performed without departing from the scope and spirit of the invention. The method 300 is described below with reference to FIGS. 1-3.

In step 305, the policy database 110 is populated and/or updated with policy data. For example, at least one insurance carrier and/or an agent or agents of the insurance carrier(s) can populate and/or update the policy database 110 via a terminal 155 or an alternative data transfer means known in the art.

In step 310, the rule database 208 is populated and/or updated with rule data. For example, the agent(s) can populate and/or update the rule database 208 via a terminal 155 or an alternative data transfer means known in the art.

In step 315, the insured database 120 is populated and/or updated with insured data. For example, the insurance carrier(s) and/or agent(s) can populate and/or update the insured database 120 via a terminal 155 or an alternative data transfer means known in the art.

In step 325, the extraction module 115 translates certain of the rule data, policy data, and/or insured data into hold data comprising a hold date. The hold date is a date until which the system 100 will delay outputting a particular generated report. For example, the hold date can be based on one or more pre-designated preferences of the insurance carrier. In certain embodiments of the invention, in accordance with the rule data, no hold date will exist. In step 330, the extraction module 115 stores the hold data, if any, in the hold database 209.

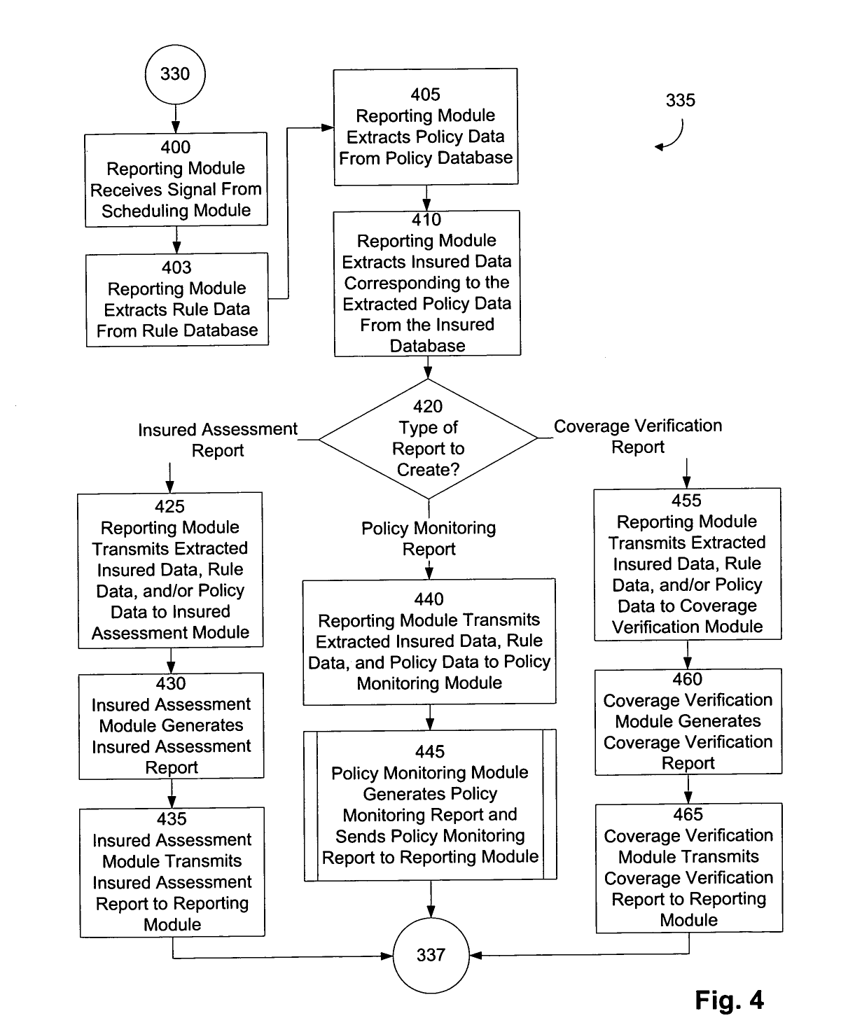

In step 335, the reporting module 207 generates a report. For example, the report can be a policy monitoring report. Step 335 is discussed in more detail below with reference to FIG. 4. The reporting module 207 stores the generated report in the report database 227 in step 337.

In step 340, the reporting module 207 determines whether to generate another report. If so, the method 300 branches back to step 335 to repeat the generation and storage of another report. If the reporting module 207 will not generate another report, then the method 300 branches to step 345.

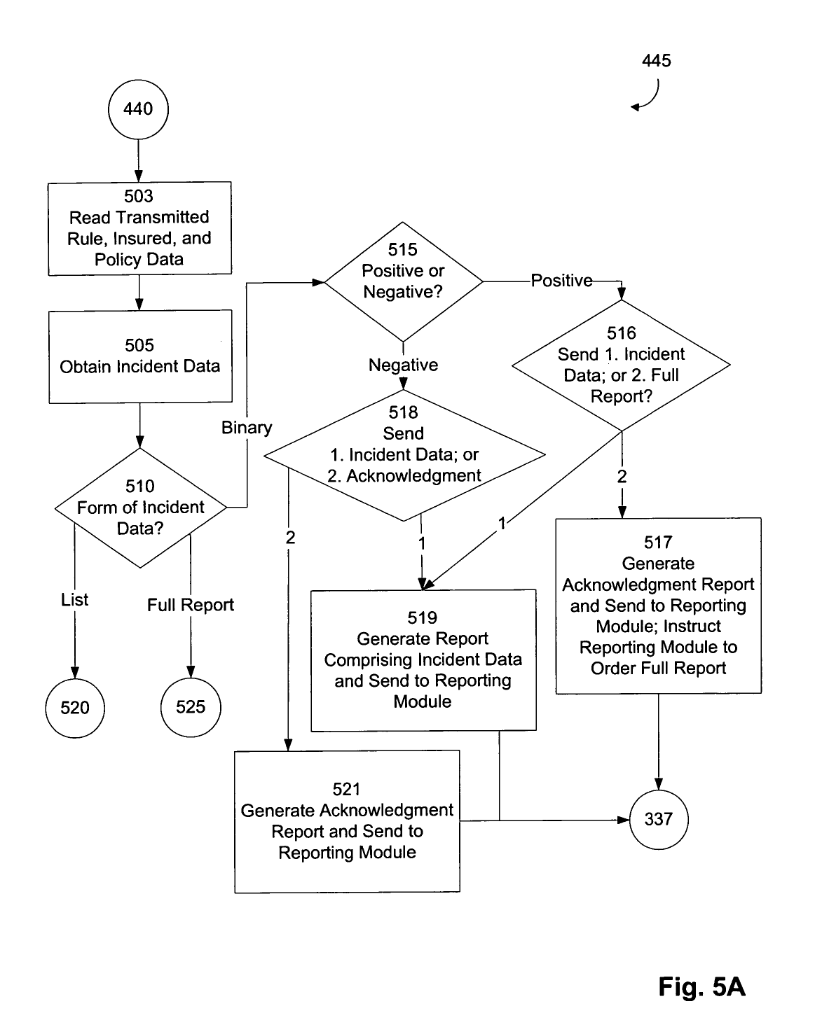

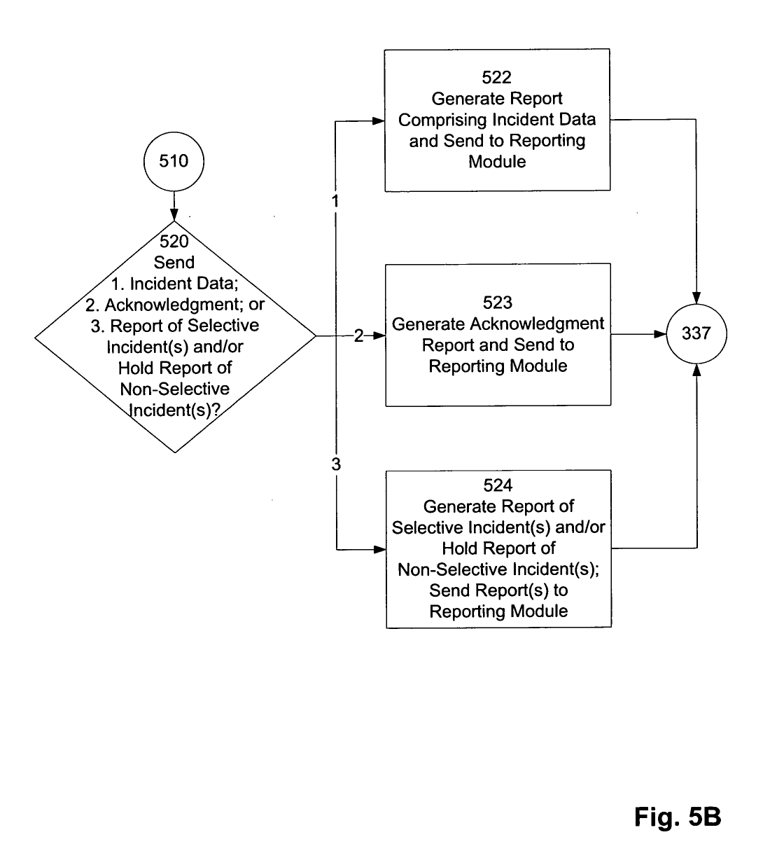

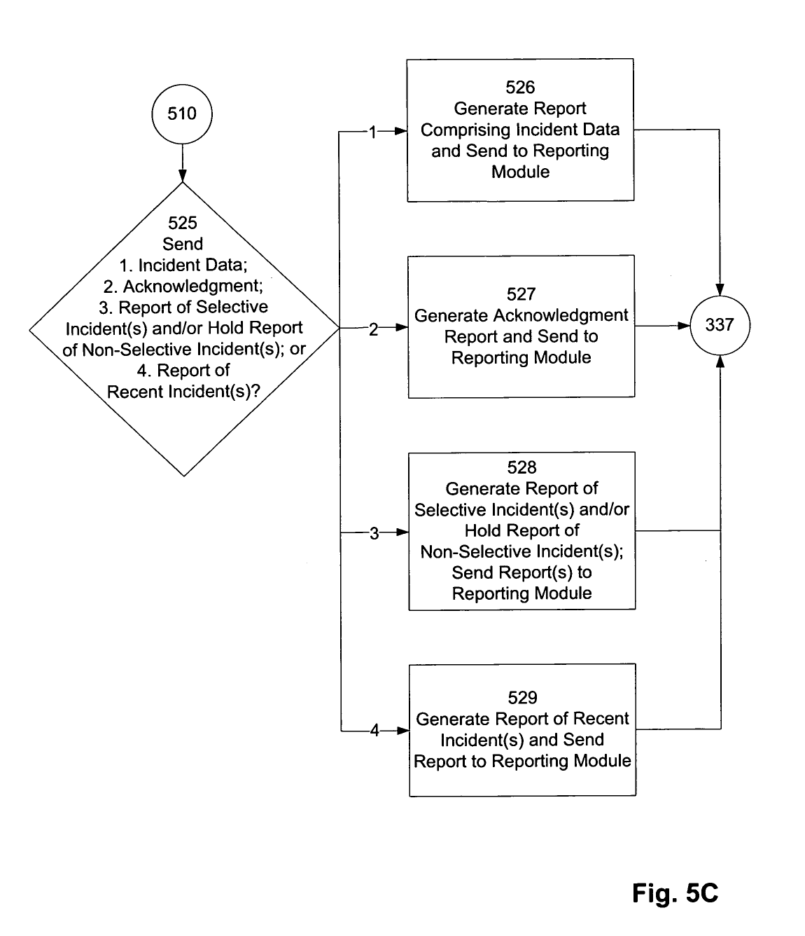

In step 345, the reporting module 207 extracts certain of the generated report(s) from the report database 227. For example, the reporting module 207 can extract non-acknowledgment reports from the report database 227. As described below with reference to step 517 of FIG. 5, an acknowledgment report is a report for internal system purposes only. An acknowledgment report will not be outputted to a report recipient.

In step 350, the reporting module 207 determines whether each extracted report is a hold report. If the reporting module 207 determines that any extracted report is a hold report, the method 300 branches to step 365. In step 365, the reporting module 207 compares the then-current date with the hold date corresponding to each hold report. For example, the reporting module 207 can determine the hold date corresponding to each hold report by accessing the hold database 209. Alternatively, if the hold report itself comprises the hold date, the reporting module 207 simply can refer to the hold report to determine the hold date.

If the then-current date is before the hold date, the reporting module 207 takes no further action with regard to the hold report; the hold report remains stored in the report database 227. If the then-current date is on or after the hold date, the reporting module 207 will output the hold report. For example, the reporting module 207 can immediately output each such hold report. Alternatively, prior to outputting the report(s), the reporting module 207 can batch the report(s) together.

For example, as illustrated in step 370, the reporting module 207 can batch the report(s) together with all of the extracted non-hold reports, if any. As used herein, the term “batch” refers to grouping and/or combining together one or more reports. For example, batching can comprise combining verbatim copies of each report into one “master” report. Alternatively, batching can comprise parsing and combining portions of each report to create a single, comprehensive report. The rule data determines the format and content of the batched report. In an alternative embodiment, the reporting module 207 can generate two sets of batched reports—one for the hold report(s) and one for the non-hold report(s).

In step 375, the reporting module 207 outputs the batched report. The term “output” is used herein to refer to any form of display or transmission. For example, the reporting module 207 can output the report by communicating a digital copy of the report to a display or a data storage device of a terminal 155. In one embodiment of the invention, the reporting module 207 can communicate an email message comprising the report to a report recipient. Alternatively, the reporting module 207 can output the report by printing the report onto paper.

If the reporting module 207 determines in step 350 that each report extracted in step 345 is not a hold report, then the method branches to step 355. In step 355, the reporting module 207 batches the extracted report(s) into a batched report. In an alternative embodiment of the invention, the reporting module 207 can separately output each report. Upon completion of step 355, the method 300 branches to step 375 discussed above.

FIG. 4 is a flow chart depicting a method 335 for generating a customized report regarding an insured person, according to an exemplary embodiment of the invention, as referred to in step 335 of FIG. 3. The exemplary method 335 is merely illustrative and, in alternative embodiments of the invention, certain steps can be performed in a different order, performed in parallel with one another, or omitted entirely, and/or certain additional steps can be performed without departing from the scope and spirit of the invention. The method 335 is described below with reference to FIGS. 1, 2, and 4.

In step 400, the reporting module 207 receives a signal from the scheduling module 206. The signal comprises instructions to the reporting module 207 to generate a report for a report recipient. For example, the report recipient can be an insurance carrier and/or an agent of the insurance carrier.

In step 403, the reporting module 207 extracts rule data from the rule database 208. The rule data comprises information regarding the report recipient's preferences, and internal rules, for the generation and output of the report. By accessing the rule data, the reporting module 207 can ensure that, in generating and outputting the report, it follows appropriate system protocol and generates and outputs the report in compliance with the report recipient's designated preferences.

For example, if an insurance carrier requests that a report be generated for each of a particular insurance carrier's insured persons who are licensed in the state of New York, the rule data will inform the reporting module 207 to access data related only to insured persons who are insured by the particular insurance carrier and who are licensed in the state of New York.

In accordance with the rule data, the reporting module 207 extracts certain of an insurance carrier's policy data from the policy database 110 in step 405. For example, where the rule data comprises the report recipient's preference to base the report on motor vehicle records of insured persons who are insured by a particular insurance carrier and who are licensed in the state of New York, the reporting module 207 can extract all of the particular insurance carrier's auto insurance policy data.

The extracted policy data comprises information regarding at least one insurance policy. In particular, the policy data comprises information identifying the person(s) insured on each insurance policy. For example, the policy data can comprise a PIN number corresponding to insured data related to the insured person(s).

In step 410, in accordance with the rule data, the reporting module 207 extracts insured data from the insured database 120. The insured data corresponds to the policy data extracted in step 405. The insured data comprises information regarding the insured person(s) insured on the insurance policy(ies) about which the extracted policy data relates.

As set forth above, where the rule data comprises the report recipient's preference to base the report on motor vehicle records of insured persons who are insured by a particular insurance carrier and who are licensed in the state of New York, the reporting module 207 can extract all of the particular insurance carrier's auto insurance policy data in step 405. In step 410, the reporting module can extract insured data corresponding to each insured person living in New York who is insured on an auto insurance policy of the particular insurance carrier.

In one embodiment of the invention, the reporting module 207 can generate a report without extracting policy data. For example, if the report will not comprise policy data and if the rule data designates a particular insured person about whom to generate a report, the reporting module 207 can generate the report without extracting both policy data and insured data.

In step 420, the reporting module 207 determines what type of report to create. In a typical embodiment of the invention, the reporting module 207 has three options: (1) an insured assessment report; (2) a coverage verification report; and (3) a policy monitoring report.

If the reporting module 207 determines in step 420 to create an insured assessment report, the method 335 branches to step 425. In step 425, the reporting module 207 sends the extracted rule data, insured data, and/or policy data to the insured assessment module 125. In step 430, the insured assessment module 125 generates the insured assessment report, and in step 435, the insured assessment module 125 sends the generated insured assessment report to the reporting module 207 to be stored, batched, and/or outputted. Upon transmission of the insured assessment report to the reporting module 207, the method 335 branches to step 337 (FIG. 3).

If the reporting module 207 determines in step 420 to create a policy monitoring report, the method 335 branches to step 440. In step 440, the reporting module 207 sends the extracted rule data, insured data, and policy data to the policy monitoring module 130. In step 445, the policy monitoring module 130 generates the policy monitoring report and sends the generated policy monitoring report to the reporting module 207 to be stored, batched, and/or outputted. Step 445 is discussed in more detail below with reference to FIG. 5. Upon completion of step 445, the method 335 branches to step 337 (FIG. 3).

If the reporting module 207 determines in step 420 to create a coverage verification report, the method 335 branches to step 455. In step 455, the reporting module 207 sends the extracted rule data, insured data, and/or policy data to the coverage verification module 135. In step 460, the coverage verification module 135 generates the coverage verification report, and in step 465, the coverage verification module 135 sends the generated coverage verification report to the reporting module 207 to be stored, batched, and/or outputted. Upon transmission of the coverage verification report to the reporting module 207, the method 335 branches to step 337 (FIG. 3).

FIG. 5 is a flow chart depicting a method 445 for generating a policy monitoring report, according to an exemplary embodiment of the invention, as referred to in step 445 of FIG. 4. The exemplary method 445 is merely illustrative and, in alternative embodiments of the invention, certain steps can be performed in a different order, performed in parallel with one another, or omitted entirely, and/or certain additional steps can be performed without departing from the scope and spirit of the invention. The method 445 is described below with reference to FIGS. 1, 2, 4, and 5.

In step 503, the policy monitoring module 130 reads the data transmitted to it in step 440. In steps 505-529 the policy monitoring module 130 obtains incident data corresponding to each insured person about whom the transmitted insured data relates, generates at least one report based on the obtained incident data, and transmits the generated report(s) to the reporting module 207. Steps 505-529 can be repeated for each insured person about whom the transmitted insured data relates.

In accordance with the rule data, in step 505, the policy monitoring module 130 obtains and reads incident data corresponding to an insured person. The procedure followed in obtaining such incident data depends on the incident data source. Each incident data source can require the policy monitoring module 130 to submit a different set of data, in a different format, to obtain the incident data.

In one embodiment of the invention, the rule data can comprise information regarding what type of data, in what type of format, each incident data source requires to obtain incident data. Based on such information, the policy monitoring module 130 can transmit appropriate data to the incident data source. The policy monitoring module 130 can receive back from the incident data source incident data that corresponds to the transmitted data.

In step 510, the policy monitoring module 130 determines in what form the incident data obtained in step 505 is. For example, the incident data can be in: (1) binary form; (2) list form; or a (3) full report form. If the policy monitoring module 130 determines in step 510 that the incident data is in binary form, the method 445 branches to step 515.

In step 515, the policy monitoring module 130 determines whether the incident data is positive or negative. A positive result indicates that the insured person's full motor vehicle record comprises data regarding a motor vehicle incident. A negative result indicates that the insured person's full motor vehicle record does not contain any data regarding a motor vehicle incident.

If the policy monitoring module 130 determines in step 515 that the incident data is positive, the method 445 branches to step 516. In step 516, the policy monitoring module 130 determines whether, according to the rule data, it will create a report comprising the incident data or instead order a full motor vehicle report from another source, such as the incident data source.

If the policy monitoring module 130 determines to create a report comprising the incident data, the method 445 branches to step 519. In step 519, the policy monitoring module 130 generates a policy monitoring report comprising the incident data and sends the generated policy monitoring report to the reporting module 207. The rule data dictates the format and content of the policy monitoring report. For example, the generated policy monitoring report can comprise rule data, policy data, insured data, and/or incident data. Upon completion of step 519, the method 445 branches to step 337 (FIG. 3).

If the policy monitoring module 130 determines in step 516 to order a full report from another source, the method 445 branches to step 517. In step 517, the policy monitoring module 130 generates an acknowledgment report and sends the acknowledgment report to the reporting module 207. The policy monitoring module 130 also instructs the reporting module 207 to order a full motor vehicle report from another source, such as the incident data source. The full motor vehicle report can comprise comprehensive information regarding the insured person's motor vehicle record.

An acknowledgment report is a report comprising an acknowledgment that the policy monitoring module 130 failed to obtain any pertinent information. For example, the policy monitoring module 130 can generate an acknowledgment report when the rule data indicates a preference of the report recipient not to receive a report unless pertinent information (e.g., detailed information regarding at least one incident) is obtained. Because the acknowledgment report is a record of non-report-outputting work performed by the policy monitoring module 130, the acknowledgment report can serve as a record by which the performance of the policy monitoring module 130 can be monitored.

The rule data dictates the format and content of the acknowledgment report. For example, the acknowledgment report can comprise rule data, policy data, insured data, and/or incident data. Upon completion of step 517, the method 445 branches to step 337 (FIG. 3).

If the policy monitoring module 130 determines in step 515 that the incident data is negative, the method 445 branches to step 518. In step 518, the policy monitoring module 130 determines whether, according to the rule data, it will create a report comprising the incident data or instead generate an acknowledgment report.

If the policy monitoring module 130 will create a report comprising the incident data, the method 445 branches to step 519 described above. If the policy monitoring module 130 determines in step 518 to generate an acknowledgment report, the method 445 branches to step 521.

In step 521, the policy monitoring module 130 generates an acknowledgment report and sends the acknowledgment report to the reporting module 207. The rule data dictates the format and content of the acknowledgment report. For example, the acknowledgment report can comprise rule data, policy data, insured data, and/or incident data. Upon completion of step 521, the method 445 branches to step 337 (FIG. 3).

If the policy monitoring module 130 determines in step 510 that the incident data is in list form, the method 445 branches to step 520. In step 520, the policy monitoring module 130 determines whether, according to the rule data, it will (1) create a report comprising the incident data; (2) create an acknowledgment report; or (3) create a report comprising information about any selective incidents corresponding to the insured data and/or create a hold report comprising information about any non-selective incidents corresponding to the insured data.

If the policy monitoring module 130 determines in step 520 to create a report comprising the incident data, the method 445 branches to step 522. In step 522, the policy monitoring module 130 generates a policy monitoring report comprising the incident data and sends the generated policy monitoring report to the reporting module 207. The rule data dictates the format and content of the policy monitoring report. For example, the generated policy monitoring report can comprise rule data, policy data, insured data, and/or incident data. Upon completion of step 522, the method 445 branches to step 337 (FIG. 3).

If the policy monitoring module 130 determines in step 520 to create an acknowledgment report, the method 445 branches to step 523. In step 523, the policy monitoring module 130 generates an acknowledgment report and sends the acknowledgment report to the reporting module 207. The rule data dictates the format and content of the acknowledgment report. For example, the acknowledgment report can comprise rule data, policy data, insured data, and/or incident data. Upon completion of step 523, the method 445 branches to step 337 (FIG. 3).

If the policy monitoring module 130 determines in step 520 to create a report comprising information about any selective incidents corresponding to the insured data and/or create a hold report comprising information about any non-selective incidents corresponding to the insured data, the method 445 branches to step 524. In step 524, the policy monitoring module 130 generates a policy monitoring report comprising information regarding any selective incidents corresponding to the insured data and/or a hold report comprising information about any non-selective incidents corresponding to the insured data.

The rule data defines whether the incident information comprises information regarding a selective incident or a non-selective incident. In addition, the rule data dictates the format and content of each generated report. The policy monitoring module 130 sends the generated report(s) to the reporting module 207. Upon completion of step 524, the method 445 branches to step 337 (FIG. 3).

If the policy monitoring module 130 determines in step 510 that the incident data is in a full report form, the method 445 branches to step 525. In step 525, the policy monitoring module 130 determines whether, according to the rule data, it will (1) create a report comprising the incident data; (2) create an acknowledgment report; (3) create a report comprising information about any selective incidents corresponding to the insured data and/or create a hold report comprising information about any non-selective incidents corresponding to the insured data; or (4) create a report comprising information about any recent incidents corresponding to the insured data.

If the policy monitoring module 130 determines in step 525 to create a report comprising the incident data, the method 445 branches to step 526. In step 526, the policy monitoring module 130 generates a policy monitoring report comprising the incident data and sends the generated policy monitoring report to the reporting module 207. The rule data dictates the format and content of the policy monitoring report. For example, the generated policy monitoring report can comprise rule data, policy data, insured data, and/or incident data. Upon completion of step 526, the method 445 branches to step 337 (FIG. 3).

If the policy monitoring module 130 determines in step 525 to create an acknowledgment report, the method 445 branches to step 527. In step 527, the policy monitoring module 130 generates an acknowledgment report and sends the acknowledgment report to the reporting module 207. The rule data dictates the format and content of the acknowledgment report. For example, the acknowledgment report can comprise rule data, policy data, insured data, and/or incident data. Upon completion of step 527, the method 445 branches to step 337 (FIG. 3).

If the policy monitoring module 130 determines in step 525 to create a report comprising information about any selective incidents corresponding to the insured data and/or create a hold report comprising information about any non-selective incidents corresponding to the insured data, the method 445 branches to step 528. In step 528, the policy monitoring module 130 generates a policy monitoring report comprising information regarding any selective incidents corresponding to the insured data and/or a hold report comprising information about any non-selective incidents corresponding to the insured data.

The rule data defines whether the incident information comprises information regarding a selective incident or a non-selective incident. In addition, the rule data dictates the format and content of each generated report. The policy monitoring module 130 sends the generated report(s) to the reporting module 207. Upon completion of step 528, the method 445 branches to step 337 (FIG. 3).

If the policy monitoring module 130 determines in step 525 to create a report comprising information about any recent incidents corresponding to the insured data, the method 445 branches to step 529. In step 529, the policy monitoring module 130 generates a policy monitoring report comprising information regarding any recent incidents corresponding to the insured data and transmits the generated report to the reporting module 207. The rule data defines whether an incident is a “recent incident.” Upon completion of step 529, the method 445 branches to step 337 (FIG. 3).

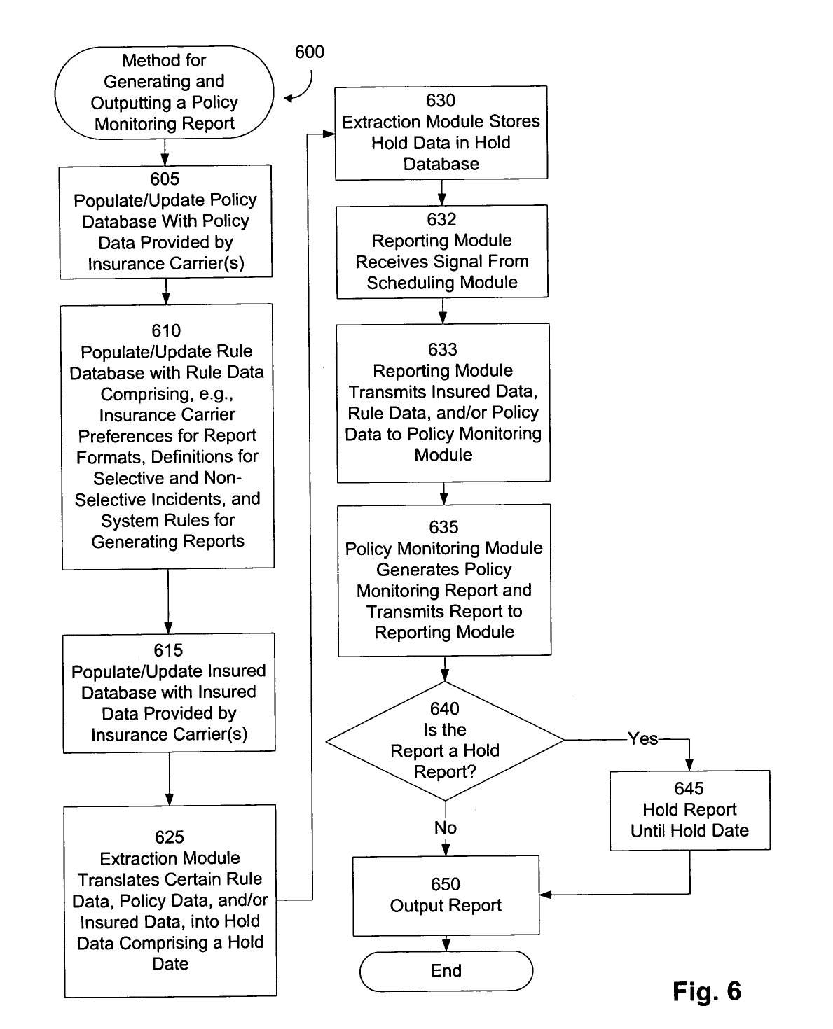

FIG. 6 is a flow chart depicting a method 600 for generating and outputting at appropriate times customized policy monitoring reports, according to an exemplary embodiment of the invention. The exemplary method 600 is merely illustrative and, in alternative embodiments of the invention, certain steps can be performed in a different order, performed in parallel with one another, or omitted entirely, and/or certain additional steps can be performed without departing from the scope and spirit of the invention. The method 600 is described below with reference to FIGS. 1, 2, and 6.

In step 605, the policy database 110 is populated and/or updated with policy data. For example, at least one insurance carrier and/or an agent or agents of the insurance carrier(s) can populate and/or update the policy database 110 via a terminal 155 or an alternative data transfer means known in the art.

In step 610, the rule database 208 is populated and/or updated with rule data. For example, the agent(s) can populate and/or update the rule database 208 via a terminal 155 or an alternative data transfer means known in the art.

In step 615, the insured database 120 is populated and/or updated with insured data. For example, the insurance carrier(s) and/or agent(s) can populate and/or update the insured database 120 via a terminal 155 or an alternative data transfer means known in the art.

In step 625, the extraction module 115 translates certain of the rule data, policy data, and/or insured data into hold data comprising a hold date. The hold date is a date until which the system 100 will delay outputting a particular generated report. For example, the hold date can be based on one or more pre-designated preferences of the insurance carrier. In certain embodiments of the invention, no hold date will exist. In step 630, the extraction module 115 stores the hold data, if any, in the hold database 209.

In step 632, the reporting module 207 receives a signal from the scheduling module 206. The signal comprises instructions to the reporting module 207 to generate a report for a report recipient. For example, the report recipient can be an insurance carrier and/or an agent of the insurance carrier.

In step 633, the reporting module 207 transmits appropriate rule data, policy data, and insured data to the policy monitoring module 130 for report generation. For example, the reporting module 207 can proceed in accordance with steps 403-440 of FIG. 4 to transmit the appropriate rule data, policy data, and insured data to the policy monitoring module 130.

Utilizing the data transmitted in step 633, the policy monitoring module 130 generates a policy monitoring report and transmits the generated report to the reporting module 207 in step 635. For example, the policy monitoring module 130 can proceed in accordance with steps 503-529 of FIG. 5 to generate the policy monitoring report and transmit the generated report to the reporting module 207.

In step 640, the reporting module 207 determines whether the generated report is a hold report. If not, the method 600 branches to step 650. In step 650, the reporting module 207 immediately outputs the generated report.

If the reporting module 207 determines in step 640 that the generated report is a hold report, the method 600 branches to step 645. In step 645, the reporting module 207 holds the generated report until the report's hold date. For example, the reporting module 207 can determine the hold date corresponding to the hold report by accessing the hold database 209. Alternatively, if the hold report itself comprises the hold date, the reporting module 207 simply can refer to the hold report to determine the hold date.

In one embodiment of the invention, the reporting module 207 and/or the policy monitoring module 207 can update the contents of each hold report and/or verify the contents of each hold report on or before the hold date.

Upon completion of step 645, the method 600 branches to step 650 discussed above.

We claim:

1. A computer-implemented method for generating a report based on an insured person's motor vehicle record, comprising the steps of:
creating insured data comprising at least one of the identity of the insured person and background information for the insured person;
creating rule data comprising (a) a selective designation designating whether certain information in the insured person's motor vehicle record is selective information or non-selective information, and (b) a formatting designation designating at least one of the format of the report and the content of the report, wherein the formatting designation depends on whether the insured person's motor vehicle record comprises at least one of the selective information and the non-selective information;
utilizing the insured data to obtain incident data comprising information regarding the insured person's motor vehicle record;
determining whether the incident data comprises at least one of the selective information and the nonselective information; and
based upon that determination, applying the formatting designation to the incident data to generate the report in accordance with the rule data.

2. The computer-implemented method of claim 1, wherein selective information is information regarding a major motor vehicle incident and nonselective information is information regarding a minor motor vehicle incident.

3. The computer-implemented method of claim 1, wherein the selective designation is created by a recipient of the report.

4. The computer-implemented method of claim 1, wherein the formatting designation is created by a recipient of the report.

5. The computer-implemented method of claim 1, wherein the step of obtaining incident data comprises the steps of:
submitting at least the insured data to an incident data source; and
receiving from the incident data source incident data that corresponds to the submitted data.

6. The computer-implemented method of claim 1, wherein the rule data further comprises an output designation designating a time at which to output the report.

7. The computer-implemented method of claim 6, further comprising the step of outputting the report at the designated time.

8. The computer-implemented method of claim 6, wherein the time of the output designation is determined by whether the report comprises the non-selective information.

9. The computer-implemented method of claim 6, wherein the output designation is created by a recipient of the report.

10. The computer-implemented method of claim 1, wherein the rule data further comprises a generation designation designating a generation time at which to generate the report.

11. The computer-implemented method of claim 10, wherein the generation designation is created by a recipient of the report.

12. The computer-implemented method of claim 10, wherein the report is generated at the generation time.

13. A computer-implemented method for generating and timely outputting at least one report based on an insured person's motor vehicle record, comprising the steps of:
creating insured data comprising at least one of the identity of the insured person and background information regarding the insured person;
creating rule data comprising (a) a selective designation designating whether certain information in the insured person's motor vehicle record is selective information or non-selective information, (b) a formatting designation designating at least one of the format and the content of each report, and (c) and an output designation designating a time at which to output each generated report, wherein the time of the output designation is determined by whether the report comprises the non-selective information;
utilizing the insured data to obtain incident data comprising information regarding the insured person's motor vehicle record;
generating at least one report by applying the formatting designation to the incident data;
determining whether each report comprises the non-selective data;
based upon that determination, determining an output time for each report by evaluating the output designation; and
outputting each report at its output time.

14. The computer-implemented method of claim 13, wherein selective information is information regarding a major motor vehicle incident and nonselective information is information regarding a minor motor vehicle incident.

15. The computer-implemented method of claim 13, wherein the selective designation is created by a recipient of the report.

16. The computer-implemented method of claim 13, wherein the formatting designation is created by a recipient of the report.

17. The computer-implemented method of claim 16, wherein the formatting designation depends on whether the insured person's motor vehicle record comprises at least one of the selective information and the non-selective information.

18. The computer-implemented method of claim 13, wherein the output designation is created by a recipient of the report.

19. The computer-implemented method of claim 13, further comprising the step of creating policy data comprising information regarding at least one insurance policy.

20. The computer-implemented method of claim 19, wherein the policy data comprises the insurance policy's renewal date.

21. The computer-implemented method of claim 19, wherein the time of the output designation is based on the renewal date.

22. The computer-implemented method of claim 13, wherein the time of the output designation is based on the insured data.

23. The computer-implemented method of claim 13, wherein the step of outputting each report at its output time comprises the steps of:
comparing each report's output time;
extracting the contents of each report that has the same output time;
generating at least one new report that comprises the extracted contents; and
outputting the generated at least one new report at the output time of each report from which the generated report was generated.

24. The computer-implemented method of claim 13, further comprising the step of:
storing each report in a data storage medium until at least its output time.

25. The computer-implemented method of claim 24, wherein the step of outputting each report at its output time comprises the steps of:
comparing the then-current time with the output time for each report;
extracting the contents of each report that has an output time on or before the then-current time;
generating a new report that comprises the extracted contents; and
immediately outputting the generated new report.

26. The computer-implemented method of claim 13, wherein the step of obtaining incident data comprises the steps of:
submitting the insured data to an incident data source; and
receiving from the incident data source incident data that corresponds to the submitted data.

27. The computer-implemented method of claim 13, wherein the rule data further comprises a generation designation designating a generation time at which to generate each report.

28. The computer-implemented method of claim 27, wherein the generation designation is created by a recipient of the report.

29. The computer-implemented method of claim 27, wherein each report is generated at its generation time.

30. A system for generating at least one report based on an insured person's motor vehicle record, comprising:
an insured data storage medium for storing insured data comprising at least one of the identity of the insured person and background information regarding the insured person;
a rule data storage medium for storing rule data comprising:
a selective designation designating whether certain information potentially contained in the insured person's motor vehicle record is selective information or non-selective information, and
a formatting designation designating at least one of the format of the report and the content of the report, wherein the formatting designation depends on whether the insured person's motor vehicle record comprises at least one of the selective information and the non-selective information; and
a policy monitoring module in communication with each of the insured data storage medium and the rule data storage medium, operable for:
utilizing the insured data to obtain incident data comprising information regarding the insured person's motor vehicle record,
determining whether the incident data comprises at least one of the selective information and the nonselective information, and
based upon that determination, applying the formatting designation to the incident data to generate, in accordance with the rule data, the report.

31. The system of claim 30, wherein selective information is information regarding a major motor vehicle incident and nonselective information is information regarding a minor motor vehicle incident.

32. The system of claim 30, wherein the selective designation is created by a recipient of the report.

33. The system of claim 30, wherein the formatting designation is created by a recipient of the report.

34. The system of claim 30, further comprising a report data storage medium for storing each generated report.

35. The system of claim 34, further comprising a reporting module operable for receiving each generated report from the policy monitoring module.

36. The system of claim 35, wherein the reporting module is further operable for storing each received report in the report data storage medium.

37. The system of claim 35, wherein the rule data further comprises an output designation designating a time at which to output each generated report.

38. The system of claim 37, wherein the output designation is created by a recipient of the report.

39. The system of claim 37, further comprising a policy data storage medium for storing policy data comprising information regarding at least one insurance policy.

40. The system of claim 39, wherein the policy data comprises the insurance policy's renewal date.

41. The system of claim 40, wherein the wherein the time of the output designation is based on the renewal date.

42. The system of claim 37, wherein the time of the output designation is based on the insured data.

43. The system of claim 37, wherein the time of the output designation is determined by whether the report comprises non-selective information.

44. The system of claim 43, wherein the reporting module is further operable for determining whether each generated report comprises non-selective information.

45. The system of claim 37, wherein the reporting module is further operable for utilizing the output designation to determine, for each generated report, an output time at which to output the report.

46. The system of claim 45, further comprising a report data storage medium, wherein the reporting module is further operable for storing each report in the report data storage medium until at least its output time.

47. The system of claim 45, wherein the reporting module is further operable for outputting each generated report at its output time.

48. The system of claim 30, wherein the rule data further comprises a generation designation designating a generation time at which to generate each report.

49. The system of claim 48, wherein the generation designation is created by a recipient of the report.

50. The system of claim 49, wherein the policy monitoring module is further operable for generating each report at its generation time.
